(19) United States
(12) Patent Application Publication
(10) Pub. No.: US 2008/0101344 A1
(43) Pub. Date: May 1, 2008

(54) Method and System to Provide Redundancy for Calls

(76) Inventors: Bizhan Karimi-Cherkandi, Boca Raton, FL (US); Farrokh Mohammadzadeh Kouchri, Boca Raton, FL (US)

Correspondence Address: SIEMENS SCHWEIZ AG;I-47, INTELLECTUAL PROPERTY, ALBISRIEDERSTRASSE 245, ZURICH, CH-8047, CH

(21) Appl. No.: 11/883,136

(22) PCT Filed: Jan. 20, 2006
(86) PCT No.: PCT/EP06/00487

§ 371 Date: Jul. 25, 2007

Related U.S. Application Data
(60) Provisional application No. 60/650,071, filed on Feb. 4, 2005.

(51) Int. Cl. H04L 12/56; H04L 29/06; H04M 7/00

(52) U.S. Cl. 370/352; 379/221.01

(57) ABSTRACT

In a method for providing redundancy for calls, a calling subscriber generates a first call to a called receiver. An originator is provided, associated to the calling subscriber, and having intelligence of creating at least one additional call associated with the first call. A terminator is provided, associated to the called subscriber, and having intelligence of recognizing the at least one additional call and referencing it to the first call.

This application claims priority to pending U.S. Provisional Patent Application Ser. No. 60/650,071 (Attorney Docket No. 2005P02059US), filed 4 Feb. 2005 the entire contents of which are incorporated herein by reference in its entirety.

The present invention relates to a method and system according the preamble of claims 1 and 7.

In datacom networks, the connectivity of a device within the network may be disrupted due to hardware or software failures causing the interruption of subscriber calls and services.

In order to ensure quality of service, service providers require network connections and systems to be as reliable as possible and as failure-safe as possible.

Since the failure of a network entity is an event impossible to be avoided, widely used methods provide redundant network entities, both hardware and software, in order to render network systems failure-safer.

In IP networks, beside the problems of network failures already present in traditional PSTN networks, there is the problem of congestion or packets-loss that occurs after the establishment of a connection. Widely known methods to minimize packet-loss in IP networks include the use of a reconnect function or the use of a redundancy function.

Unfortunately, the synchronization of redundant software functions is a very complicated process and introduces high implementation costs in addition to the costs of the required extra-hardware for the redundant elements.

Moreover, to implement such process, a dedicated synchronization channel is required between the redundant entities.

Nevertheless, such known redundant systems are still failure vulnerable. In fact double failure can still occur and the huge amount of required software development renders such redundant systems complex and vulnerable.

Other used methods include measures for controlling congestion such as, for example, DQoS.

Unfortunately also such controlling congestion methods have the drawback of being very costly since they require additional hardware and they also require ad-hoc signaling.

It is therefore the aim of the present invention to overcome the above mentioned drawbacks, in particular the high costs for the required extra-hardware and software.

The before mentioned aim is achieved by a method with the steps of claim 1 and by a system with the features of claim 7.

Embodiments of the present invention, having certain advantages, are given in the dependent claims.

Within the scope of the present invention, a method and a system are provided which render calls failure-safer.

The proposed method and system allow calls to be less vulnerable to network failures in an easy to manage manner.

The proposed method and system does not require the presence of redundant entities or of redundant synchronization software or hardware.

The invention will now be described in preferred but not exclusive embodiments with reference to the accompanying drawings, wherein:

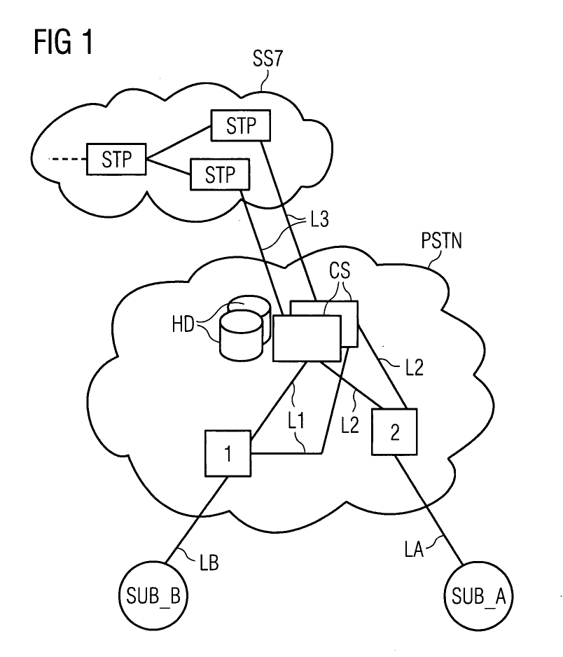

FIG. 1 is a block diagram of a traditional redundancy system in a PSTN network;

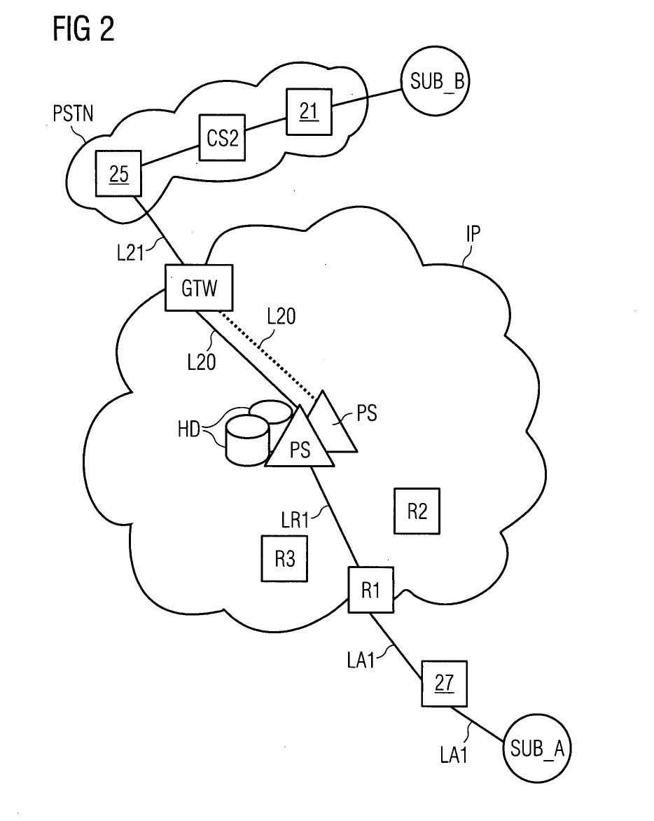

FIG. 2 is a block diagram of a prior art redundancy system in a NGN;

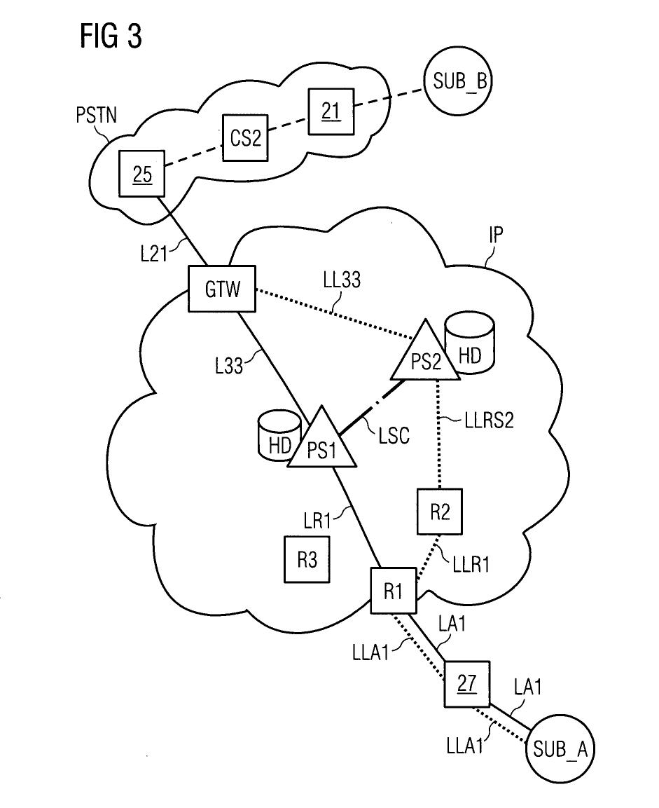

FIG. 3 shows a block diagram of an example embodiment according to the present invention of a redundant call between a VOIP subscriber and a TDM subscriber;

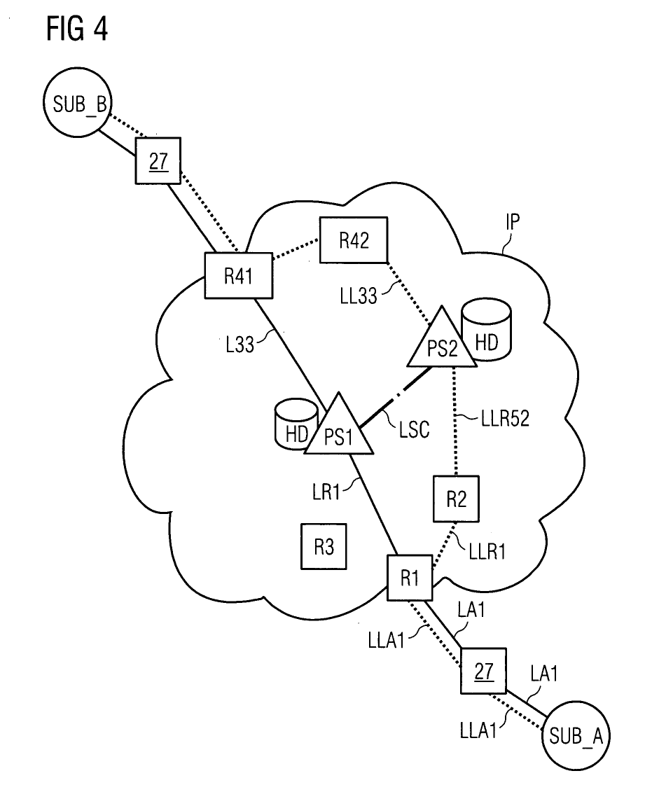

FIG. 4 shows a block diagram of a further example embodiment according to the present invention of a redundant call between two VOIP subscribers;

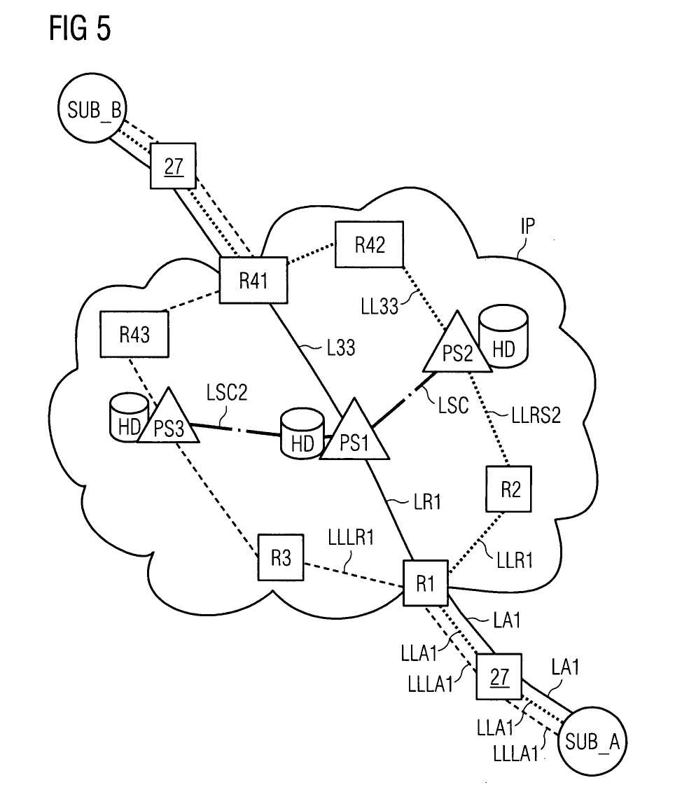

FIG. 5 shows a block diagram of a further example embodiment according to the present invention of a N+1 redundant call;

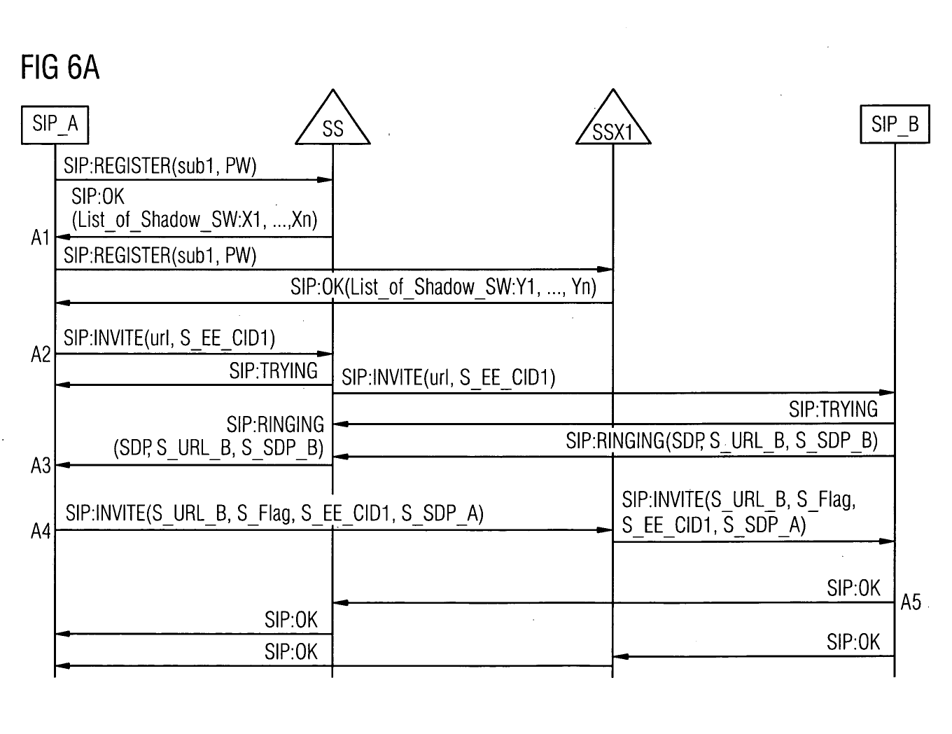

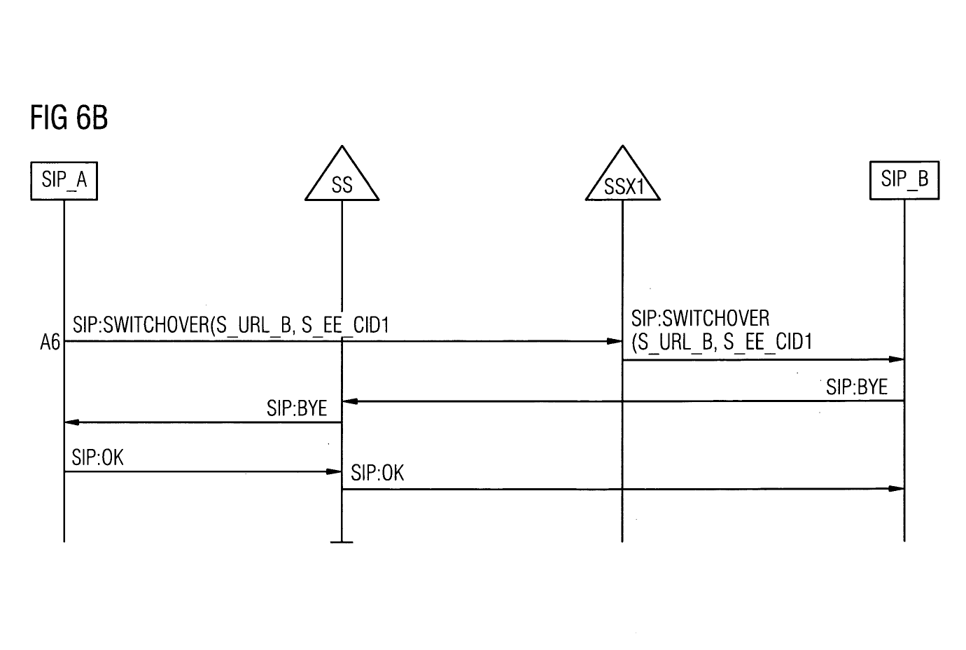

FIGS. 6A and 6B show a block diagram of a further example embodiment according to the present invention of a message flow for SIP signaling.

FIG. 1 shows a block diagram of a prior art system with redundant network entities in a TDM network.

The subscriber SUB_A and subscriber SUB_B are the phone terminals of the calling and receiving parties respectively.

The two end terminals SUB_A and SUB_B are connected, via links LA and LB, to two line concentrator modules 1,2 respectively. In case of a company or office network, PBXs may replace line concentrator modules 1,2.

The two line concentrator modules 1,2 are connected to circuit switches CS. Circuit switch networks CS may include line trunk groups and central processors. Hard drives HD are coupled to circuit switches CS. Links L3 represent the connections between circuit switches CS to other networks through SS7 including a variety of STPs.

Redundancy, in TDM networks, is mainly provided in the line concentrators 1, 2, in the hardware and in the software of the line trunk groups, in the hardware and in the software of circuit switches CS, in the connections, not shown, between the line trunk groups and circuit switches CS, in the central processors and in their I/Os not shown, in hard drives HD, in the links and in the connections between offices, not shown.

In FIG. 1, the network elements 1, 2, CS, HD, links L1, L2, connecting the line concentrator modules to circuit switches CS, and link L3 are redundant. In particular, circuit switches CS and line concentrators 1, 2 include also a software redundancy process that requires synchronization functions in two hardware systems. Instead, in FIG. 1, the network entities LA and LB are not redundant.

FIG. 2 shows a prior art system with redundant network entities in a NGN.

In the IP network are shown routers R1, R2 and R3, packet switches PS, hard drives 24 and gateway GW.

Switches PS and hard drives HD coupled to them are provided with a redundant architecture.

Connection L20 between switches PS and gateway GW is redundant. In particular, switches PS include also a software redundancy functionality that requires synchronization functions in two hardware systems.

The connection LR1 between the edge router R1 and packet switches PS can be made redundant depending on the reroute function of the router R1. In fact, if router R1 is configured to know only one destination, then link LR1 cannot be made redundant.

Router R1, link LA1, connecting end point SUB_A to edge router R1 via residential gateway RGW, and gateway GW are not redundant.

As seen in FIG. 2, the introduction of IP adds to the network an additional connection, link LA1, which is not covered by prior art NGN redundancy. Network element RGW represents a residential gateway, e.g. a home router or an IP access point, located at the customer premises.

Subscriber SUB_A may engage, via an IP network, in a call with TDM-network-subscriber SUB_B. PSTN network elements 21 and CS2 are a line concentrator 21 connected to the end point SUB_B and a circuit switch CS2. Network element 25 is a TDM access, such as a line concentrator, between circuit switch CS2 and gateway GW.

FIG. 3 depicts an example embodiment according to the present invention of redundancy between a VOIP-subscriber SUB_A and a TDM-network-subscriber SUB_B. The continuous line depicts the path of a regular prime-call or active connection, established between subscribers SUB_A and subscriber SUB_B. The dotted line represents a second call created, according to the present invention, in order to provide redundancy for the prime-call. This call shall be marked as a “shadow-call” or as a “redundant call” of the prime one.

In FIG. 3, the redundant-call of the prime call is created at the originating end point (either subscriber SUB_A or at the residential gateway RGW). The IP-connection is splitted at the edge router R1 where the active connection follows the path represented by the continuous line, links LR1 and L33, and the redundant-call follows the path of the dotted line, links LLR1, LLRS2 and LL33.

FIG. 4 shows a further embodiment of the present invention where the two subscribers SUB_A, SUB_B are two VoIP subscribers. The two end-points SUB_A and SUB_B are any type of IP end-point including Media Gateways. Packet switches PS1, PS2 may be realized as soft switches.

The prime-call is established over a non-redundant first soft switch PS1 while the shadow-connection is established over a second soft switch PS2.

First and second switches PS1, PS2 can be unaware of each other. In a further embodiment of the present invention, the redundant soft switches PS1, PS2 may be able to communicate and handle the redundant-call. The dashed-dotted link LSC represents a synch channel that may conveniently be added between switch PS1 and switch PS2.

Originating point SUB_A has the intelligence to originate a redundant-call and terminating point SUB_B or gateway GW, in case terminating point SUB_B is a TDM entity, has the intelligence to recognize a redundant-call.

End-points SUB_A, SUB_B, GW with intelligence are end-devices with processors and software. Intelligent originating points SUB_A are devices that can be programmed in a manner that, at the time of the establishment of the prime-call, they are able to create a redundant shadow-call using a different set of routes. Similarly, terminating-end points SUB_B (in FIGS. 4 and 5) and GW (in FIGS. 2 and 3) have the intelligence to differentiate between two different incoming calls, a prime and a redundant calls, and to associate the redundant-call to the prime-call.

In order to create a shadow-call, originator SUB_A needs not to wait for the prime-call to reach a stable condition.

In order to establish a redundant-call, originating end-point SUB_A exchanges the terminating end-point identity.

The shadow-call is referenced to its ongoing prime-call.

Originating end-point SUB_A assigns a call reference number to the prime-call and utilises this reference number in the shadow call so that the terminating end-point SUB_B, GW is able to make the association between the two calls.

Terminator SUB_B or gateway GW associates the redundant-call to the prime-call and understands that the second call is the redundant version of the prime-call so that the redundant-call does not ring when reaching the terminating end-point SUB_B.

According to the present invention, each of the terminating end points SUB_B or terminating gateways GW advantageously switches to the redundant-call in case of failure of the prime-call.

In a further embodiment of the present invention, the decision to switch from the prime call to the redundant-call may be taken by the end-points SUB_B or terminator gateway GW or by the switches PS1, PS2 based on criteria such as packet loss, signaling loss or reduced quality.

The second switch PS2, to which the redundant call is directed, understands the shadow-call request to identify the route to the specified termination and handles the shadow-call correspondingly.

A marker is assigned to the shadow-call setup request, so that switch PS2 differentiates a redundant-call from a prime-call and it does not assign any bearer to the shadow-call.

In another embodiment of the present invention, in order to ease the process of establishing a shadow-call, the originator SUB_A and the terminator SUB_B become aware of each other before one of them initiates the shadow-call, as it is later described in an exemplary embodiment of call flow for SIP signaling.

The skilled in the art easily understands that the number of redundant-calls needs not be limited to one. In fact, the higher the number of shadow-calls assigned to a prime-call, the safer is the call from network failures.

N number of switches may flexibly be used to become the redundant partner for each particular redundant-call.

Moreover, in a further embodiment of the present invention, at any point in call, if any of the end-points SUB_A, SUB_B, GW decides to switch to a shadow-call, a new shadow-call may be created to provide a certain requested reliability level.

FIG. 5 illustrates a further exemplary embodiment of the present invention in which N+1 redundancy is provided where N=2. In FIG. 5, the prime-connection path is represented by a continuous line and the two redundant-call paths are represented by a dotted line and by a crossed line. In edge router R1 the paths of the three calls are splitted. From edge router R1 three different links LR1, LLR1, LLLR1 depart towards three different packet switches PS1, PS2 and PS3. Conveniently, in order to minimize the impacts of network failures in an existing IP-network, different domains can be assigned to redundant switches. In this manner, different routes are invoked for the prime call and its associated redundant-call.

Advantageously, the process of having redundant calls according to the present invention may provide a scalable redundancy. In fact N shadows-calls can be created, where N can be zero or greater. Conveniently, such scalability has the advantage that it may be desired in particular cases, for commercial reasons, to provide no redundancy and thus having N=0.

End-points and switches communicate according to the present invention via a signaling that can be standardized.

Having standard signaling, switches from different vendors are able to interoperate and handle the redundant calls.

Moreover, switches PS1, PS2, PS3 involved in a redundant call may be spread in the networks of different service providers such that the redundancy is service provider independent.

Advantageously, in end-points SUB_B, GW the redundant-call shall not seize any resources regarding to media. In fact, the only seized resources are media ports, but such media ports do not transmit, receive or process any media data as long as they are in a shadow or dormant mode. Media ports may be located in gateways GW, in residential gateways RGW, in routers R41, R42 and in VOIP end-points SUB_B such as for example SIP-phones.

When it is required, the same resources seized for the prime-call shall be assigned to the redundant-call in transition as long as the seized resource is not faulty.

Once the primary-call and media encounters any problem like loss of packets, loss of data or poor quality, the intelligent point SUB_B can request the partner in the call to switch to the shadow call and media and activates the shadow call from dormant to active in use.

The skilled in the art easily understands that regular calls may be made redundant, according to the present invention, also in a traditional PSTN network.

In fact, TDM switches and, in particular, class 4 switches can be invoked for the routes of the redundant calls.

When the present invention is applicable to TDM switch-elements CS, advantageously neither redundant line trunk groups, nor redundant central processor, nor redundant RAID hard drives HD may be needed. In such a case the single point of redundancy may conveniently be reduced to the concentrator or access point 25.

Similarly, the present invention can be applied to a PBX that can be seen as a TDM switch for a smaller group of users within a company or office.

To secure the call, in prior art redundancy methods several software and hardware entities are made redundant.

Advantageously, according to the present invention, the call itself is made redundant.

The present invention, differently from prior art redundancy methods, in which several network entities are made redundant, requires redundancy only for functionalities.

Conveniently, the present invention does not require a synchronization processor or software redundancy. Hence, the present invention may be carried out even without a Residual Telecom Platform.

For the above reasons, the present invention provides reliable calls at lower implementation costs.

Moreover, the present invention provides wider coverage of the parts of the connection.

FIGS. 6A and 6B show an exemplary embodiment, according to the present invention, of a message flow for SIP signaling.

In step A1, when responding to registration, the registrar may additionally indicate a list of switches X1, . . . , Xn which can be used as shadow switches. CPE SIP_A uses this information to register by the shadow switches, e.g. the switch X1 SSX1, as optional parameter in which case subscriber database shall also be known by the shadow switches. The shadow switch SSX1 may also include a list of other shadow switches Y1, . . . , Yn in the register response to the CPE SIP_A.

In step A2, the CPE SIP_A requires to generate a unique reference number for the call to be used end-to-end. This reference number S_EE_CID1 is included in the INVITE messages optional parameter. Switch SS shall also indicate this unique reference number to the other end-point SIP_B by including it in the INVITE message. If the terminating end point SIP_B does not recognize this parameter, then it shall be ignored.

In step A3, the terminating end point SIP_B shall honor the request of the originator SIP_A for building a shadow call, by indicating the shadow SDP and the URL that shall terminate the shadow call. If the end point SIP_B is not capable of understanding shadow call parameters, then this optional parameter shall not be included, and the originator CPE SIP_A shall deduct the incapability of the terminating end point SIP_B to handle a shadow call. Since the RINGING message is not mandatory and it can be substituted by the OK message, these parameters may also be applicable for the OK message.

In step A4, the originating CPE SIP_A has the option of building the redundant-call. The CPE SIP_A sends an INVITE message to the shadow switch SSX1 indicating the shadow nature, using the flag S_Flag, the end-to-end called S_EE_CID1 and the new SDP which to be substituted in case of switchover. Since this INVITE message indicates the shadow nature of the call, the switch SSX1 shall not attempt to analyse or route the call.

When the prime-call is answered, the terminating end point SIP_B shall signal with an OK message for the prime-call and for the redundant call. In case the call is released, both calls shall be released.

In step A6, in case a switchover is needed, e.g. for media poor quality reasons, the CPE SIP_A send the new SWITCHOVER message to the shadow switch X1. The switchover shall be indicated to the terminating end point by the shadow switch SSX1. The terminating end point SIP_B shall honor this request and shall also release the primary call using the BYE message.

Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

### LIST OF REFERENCE SIGNS

1, 2 line concentrator
21 line concentrator
25 TDM access, line concentrator, access point
RGW residential gateway, IP access point, home router
CS circuit switches, switching networks
CS2 circuit switch
GW gateway
HD hard drive
L1, L2 connections between line concentrators and switching networks
L3 connections between switching networks and other networks
LSC sync channel
PS, PS1, PS2, PS3 packet switch, switch, soft switch
SIP_A CPE, end-point, originator
SIP_B CPE, end-point, terminator
SS, SSX1 switch
SUB_A phone terminal, subscriber, end terminal, Media Gateway end point, end point, IP-end points, originator, originating end-point, originating point
SUB_B phone terminal, subscriber, end terminal, Media Gateway end point, end point, IP-end points, terminator, terminating end-point, terminating point
   List of Acronyms
   CPE customer premises equipment
   DLU digital line unit
   DQoS dynamic quality of service
   I/O Input Output
   IP internet protocol
   NGN next generation network
   PBX private branch exchange
   RAID redundant array of independent disks
   SDP session description protocol
   SIP session initiation protocol
   SS7 signaling system 7
   STP signal transfer point
   TDM time division multiplexing
   VoIP voice over IP
   URL universal resource locator

1. A method for providing redundancy for calls, comprising:
generating a first call by a calling subscriber to a called receiver;
providing an originator, associated to said calling subscriber, having intelligence of creating at least one additional call associated with said first call; and
providing a terminator, associated to said called subscriber, having intelligence of recognizing said at least one additional call and referencing it to said first call.

2. The method according to claim 1, further comprising:
switching, by said originator and by said terminator, between said first call and said at least one additional call.

3. The method according to claim 2, wherein
said step of switching is performed when a call quality reaches a certain level.

4. The method according to claim 1 further comprising:
routing over different network entities paths of said first call and of said at least one additional call.

5. The method according to claim 1, further comprising:
establishing the paths of different additional calls over different network entities.

6. The method according to claim 4, wherein
said network entities include packet switches and an edge router for splitting said paths.

7. A system for providing redundancy for calls, where a calling subscriber generates a first call to a called receiver,
comprising:
an originator, associated to said calling subscriber, having intelligence of creating at least one additional call associated with said first call; and
a terminator, associated to said called subscriber, having intelligence of recognizing said at least one additional call and referencing it to said first call.

8. The system according to claim 7, further comprising:
means for switching, by said originator and by said terminator, between said first call and said at least one additional call.

9. The system according to claim 8, wherein
said means for switching perform the switching when the call quality reaches a certain level.

10. The system according to claim 7, further comprising:
means for routing over different network entities paths of said first call and of said at least one additional call.

11. The system according to claim 7, further comprising:
means for establishing the paths of different additional calls over different network entities.

12. The system according to claim 10, wherein
said network entities include packet switches and an edge router for splitting said paths.
